(19) United States
(12) Patent Application Publication
(10) Pub. No.: US 2011/0090048 A1
(43) Pub. Date: Apr. 21, 2011

(54) Data Transmission Device with User Identification Capability

(76) Inventors: Conan K. Li, Los Altos, CA (US); Richard Munden, Carson City, NV (US)

(21) Appl. No.: 12/892,541

(22) Filed: Sep. 28, 2010

Related U.S. Application Data
(60) Provisional application No. 61/277,694, filed on Sep. 29, 2009.

(51) Int. Cl. G06F 7/04

(52) U.S. Cl. 340/5.82

(57) ABSTRACT

The present invention provides, in one embodiment, a medical test data acquisition device that acquires both a test subject's test results and one or more biometric indicators such as a fingerprint, and links the test results to the biometric indicators or the test subject's identity associated with the test subject, and transmits the linked information to a data repository accessible by a medical provider. Such a device provides an accurate, portable, and low cost solution for acquiring and transmitting a test subject's medical test results in conjunction with the subject's identity.

### CROSS REFERENCE TO RELATED APPLICATIONS

This application claims priority under 35 U.S.C. §119(e) to U.S. Provisional Application No. 61/277,694, filed Sep. 29, 2009, and entitled “DATA TRANSMISSION DEVICE WITH USER IDENTIFICATION CAPABILITY,” the disclosure of which is hereby incorporated by reference in its entirety.

### BACKGROUND OF THE INVENTION

1. Field of Invention

The present invention relates to medical testing and more specifically, to a system, a method, and a portable home medical test device for acquiring and transmitting medical test data and one or more biometrics associated with a test subject.

2. Description of Related Art

Test subjects who require regular medical testing are increasingly performing self-testing, often at home. Medical testing in hospitals and other institutions is also increasingly being performed near-patient or at the point-of-care. In all cases, the test results must be reported to a laboratory database, electronic medical record, or other information system accessible by the medical provider in an accurate and timely manner. Wireless data transfer devices exist that send medical results directly from the test device to a centralized computer database of the medical test provider, so the user does not have to transcribe or copy the test results from the test device and report them by making a phone call or typing a message. This minimizes the possibility of human error affecting the medical test.

Several data transfer hubs have been developed that transfer a medical test result from an off-the-shelf medical self-test device, by telephone line or by Internet, to a database that is accessible by one or more medical providers. The MetrikLink by iMetrikus (Mountain View, Calif.) and the HealthPAL by MedApps (Scottsdale, Ariz.) are examples of such hubs. These medical data transfer hubs connect to a conventional medical test device, such as a glucose meter or a blood pressure meter, and transfer medical data from the test device through a phone line or computer interface to a medical provider-accessible database.

However, conventional medical test devices and data transfer hubs have a drawback in that they cannot uniquely identify the test subject and link the acquired medical test data with the test subject without some form of human intervention. That is, there exists no technique for entering, verifying and/or confirming the identity of the test subject who underwent the medical test at the medical test device. As an increasing number of households, medical providers, and living centers are utilizing portable medical test devices on numerous test subjects, there is a growing risk that an acquired medical test result may be associated with the wrong test subject.

### SUMMARY OF THE INVENTION

The present invention overcomes these and other disadvantages of the prior art by providing, in at least one embodiment, a medical test data acquisition device that acquires both a test subject's test results and one or more biometric indicators that are specific or unique to the test subject such as a fingerprint, and links the test results to the biometric indicators or the test subject's identity as ascertained from the biometric indicators, and transmits the linked information to a data repository accessible by a medical provider. Such a device provides an accurate, portable, and low cost solution for acquiring and transmitting a test subject's medical test results in conjunction with that test subject's identity.

In an embodiment of the invention, a transmission device comprises: a processor; a data input attached to the processor, the data input configured to receive a medical test result; a biometric scanner attached to the processor, the biometric scanner configured to receive scanned biometric information from a test subject; a memory attached to the processor, the memory configured to store test subject user identification and test subject biometric information, wherein the processor receives scanned biometric information corresponding to the user identification and the processor links the user identification to the medical test result; and a transmitter attached to the processor, the transmitter configured to transmit the linked user identification and medical test result. The medical test result comprises information selected from the group consisting of: date and time of test, type of test, test result, test calibration information, test control results, lot numbers of test materials, expiration date of test materials, medical test device identification, medical test device calibration information, information on the status of the medical test device, and any combination thereof. The data input can be attached to a cable, which is attached to a test device. The data input can also be through wireless means such as Bluetooth, WiFi, or an infrared signal. The transmitter communicates with a network, which communicates with a data repository accessible by a medical provider.

In another embodiment of the invention, a transmission device comprises: a processor; a data input attached to the processor, the data input configured to receive a medical test result; a biometric scanner attached to the processor, the biometric scanner configured to receive scanned biometric information from a medical test subject, wherein the processor receives the scanned biometric information and the processor links the scanned biometric information to the medical test result; and a transmitter attached to the processor, the transmitter configured to transmit the linked scanned biometric information and medical test result. The transmission device may further comprise a memory for storing at least one of a medical test result, a test subject's biometric information, and a test subject's user identification. The data input can be attached to a cable, which is attached to a test device. The data input can also be through a wireless connection or interface with the test device. The transmitter communicates with a network, which communicates with a data repository accessible by a medical provider. The authentication of the quality of biometric information and the match of the biometric information with the user identification can be performed at the data repository. A receiver may be included for receiving confirmation from the data repository that the medical test result and the test subject's biometric identification have been received and that the biometric information has been authenticated and matched with a user identification. The transmission device may further comprise a medical test device.

In yet another embodiment of the invention, a method of transmitting medical information comprises: receiving a medical test result; scanning biometric information from a test subject; linking the scanned biometric information to the medical test result; and transmitting the linked scanned biometric information and medical test result. The method may further comprise receiving a user identification corresponding to the scanned biometric information, storing the user identification, linking the user identification to the medical test result, and transmitting the linked user identification and medical test result.

Embodiments of the present invention have several advantages over existing technology. For example, multiple test subjects can use the same test device without the risk of test results being associated with the wrong test subject. Moreover, the present invention eliminates the need for recording a test device serial number and/or patient wristband identification. Furthermore, the present invention is more affordable—according to at least one embodiment, a complete device including housing, circuit board, and light emitting diode (LED) can retail for less than $100. The present invention eliminates the need to memorize, store, or correctly recall a test subject's user identification (“user ID”) such as a password, pin number, name and birth date, social security number or other identifying information input by a human. Although a password, for example, may link a test subject with the respective test result such that a single test device could be shared among users in one household, hospital, or clinic, the need to correctly retrieve or memorize a password could lead to complications. By not requiring a password, a test subject is not burdened by the need to remember or store the password. This is especially important when the test subject has a bad memory, such as a test subject in a rest home, or a test subject with dementia. Additionally, a hospital, clinic, or rest home does not need to be concerned with storing and retrieving the correct password for the correct test subject. It is especially important that a medical provider not confuse one test subject's medical test results with that of another test subject.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, and the advantages thereof, reference is now made to the ensuing descriptions taken in connection with the accompanying drawings briefly described as follows:

FIG. 1 illustrates a medical test system according to an embodiment of the invention;

FIG. 2 illustrates a transmission device according to an embodiment of the invention; and

FIG. 3 illustrates a flow chart showing the process of linking a test subject's biometric information with the result of the test subject's medical test according to an embodiment of the invention.

### DETAILED DESCRIPTION OF EMBODIMENTS

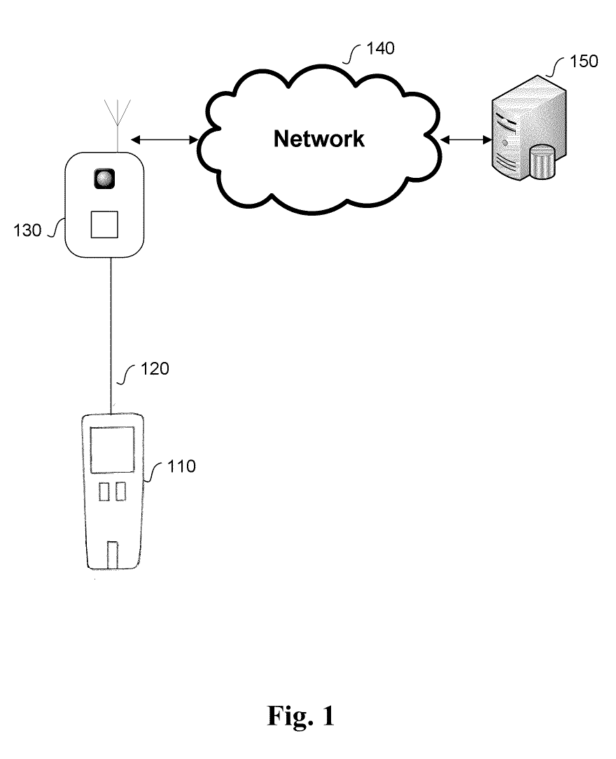

Further features and advantages of the invention, as well as the structure and operation of various embodiments of the invention, are described in detail below with reference to the accompanying FIGS. 1-3, wherein like reference numerals refer to like elements. Although embodiments of the invention are described in the context of self-medical testing at home, one of ordinary skill in the art readily appreciates that the present invention can be implemented in other types of test settings such as, but not limited to hospital, medical clinic, urgent care center, emergency department, nursing home, senior living center, convalescent home, government facility, detention facility, military facility, and school.

The present invention provides, in at least one embodiment, an improved medical test data transmission device that receives or acquires a test subject's test results from an attached or internal medical test device, while at the same or nearly the same time acquires one or more biometric indicators from the test subject. Biometric indicators (“biometrics” or “biometric information”) include physiological characteristics such as, but not limited to physiological fingerprints, facial patterns, DNA, palm print, hand geometry, iris or retina, or odor/scent. Biometric indicators may also include behavioral characteristics such as, but not limited to voice, gait, and organ rhythms. The test results are linked to the biometric indicators. Communication circuitry is included to transmit the linked information to a data repository accessible by a medical provider. The biometric indicators are authenticated at either a transmission device or a remote computer or data repository to identify the test subject associated with the test results.

Biometrics have been used to identify a user for security purposes, such as determining if a user is allowed authorized access to electronic information or a physical facility. In contrast, embodiments of the present invention use biometrics to identify a test subject such that the test subject can be accurately “linked” to test results, as opposed to determining if a user should be provided “access” to the test device or the test results. The linked information is then easily and accurately transmitted to a database for a medical provider's review. Advantageously, the transmission device allows multiple test subjects to use the same test device, without expensive and cumbersome technology such as wristbands, keypads, or displays, and there is no need to memorize, store, or correctly recall a test subject's user ID.

FIG. 1 illustrates a medical test system 100 according to an embodiment of the invention. The medical test system 100 comprises a medical test device 110, a communications medium 120, a transmission device 130, a network 140, and a data repository 150. Exemplary medical test devices 110 include, but are not limited to a glucose monitor; a blood pressure monitor; a blood alcohol monitor; breath analyzer; drug detection instrument; coagulation monitor or instrument; pulse oximeter; electrocardiogram (EKG or ECG) machine; echocardiogram machine; nuclear magnetic resonance (NMR) imaging machine, computerized axial tomography (CAT) scanner; ultrasound imaging machine; point-of-care test instruments for measuring acute disease markers or disease risk markers such as troponin, the MB isoform of creatine kinase (CKMB), myoglobin, D-Dimer, B-type natriuretic peptide (BNP), and the N terminal fragment of BNP, total cholesterol, low density lipoprotein (LDL), high density lipoprotein (HDL), LDL subclasses, HDL subclasses, triglycerides, C-reactive protein, LpPLA₂, myeloperoxidase, fatty acid-binding protein, and netrophil gelatinase-associated lipcalin; point-of-care instruments for measuring infectious disease markers such as bacterial markers, viral markers, hepatitis virus antigen and antibody markers, HIV markers, HTLV markers, and HSV markers, markers of respiratory infections such as influenza, and respiratory syncytial virus; point-of-care genetic or genotyping test instruments for measuring genetic sequences of mutations for infectious diseases, cancer, drug susceptibility, drug resistance, drug metabolism efficacy or disease risk; diabetes monitoring instruments that measure glucose and/or hemoglobin Alc; point-of-care test instruments for measuring women's health and fertility markers such as beta-hCG, LH, fetal fibronectin, and HPV; point of care test instruments for measuring cancer markers such as CA-125, AFP, PSA, NMP-22, CA 15-3, BR 27.29 (CA27.29), CA 19-9, carcinoembryonic antigen (CEA), tissue polypeptide antigen, tissue polypeptide specific antigen, and HER-2 (the extracellular domain); point-of-care instruments for measuring the comprehensive metabolic panel, including any or all of glucose, calcium, albumin, total protein, sodium, potassium, carbon dioxide or bicarbonate, chloride, blood urea nitrogen, creatinine, alkaline phosphatase, alanine aminotransferase, aspartate aminotransferase, bilirubin; and point-of-care hematology analyzers for measuring, among other parameters, red blood cell (RBC) count, white blood cell count, platelet count, platelet volume, leukocyte differential count and/or proportion, hemoglobin, hematocrit, RBC volume, RBC hemoglobin, erythrocyte sedimentation rate, and reticulocyte count. However, one of ordinary skill in the art appreciates that any type of physiological monitor may be implemented as the medical test device. The communications medium 120 permits data to be transmitted from the medical test device 110 to the transmission device 130. The communications medium 120 may take any form, the implementation and identification of which is apparent to one of ordinary skill in the art. For example, the communications medium may comprise a wired cable or a wireless channel such as Bluetooth, infrared or WiFi. A wired connection implemented as the communication medium 120 has certain advantages. First, the medical test device 110 and the transmission device 130 do not have to have their transmitters and detectors lined up for inter-device communication as would be the case with infrared linkage. Second, the medical test device 110 and the transmission device 130 would remain in close proximity as a reminder to the user to transmit the results. Also, wireless communications protocols such as Bluetooth typically require re-establishment of the communications connection. Alternatively, the test device 110 may be provided as part of the transmission device 130, thereby eliminating the need for a separate communications medium 120.

The medical test system 100 automatically communicates test results or other information from the test device 110 to the transmission device 130, and then to the data repository 150, which may comprise a computer server, database, or other type of data storage where a medical provider can access it in real time or at a later time. The medical provider can be a caregiver, physician, nurse, or other authorized party.

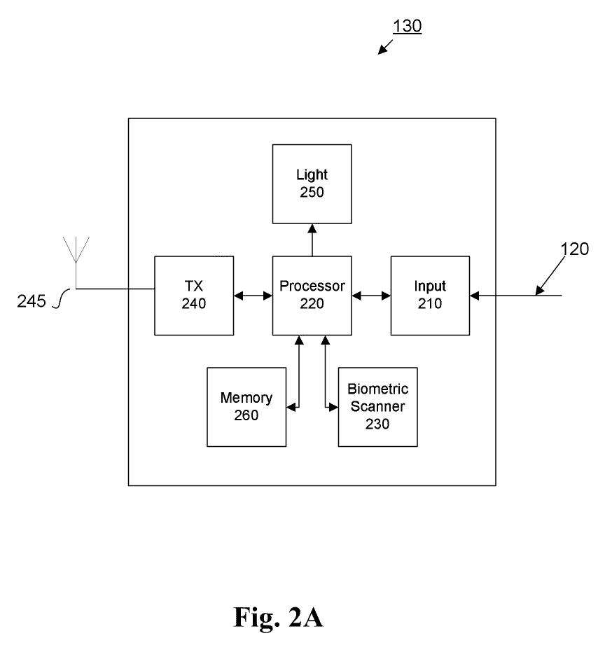

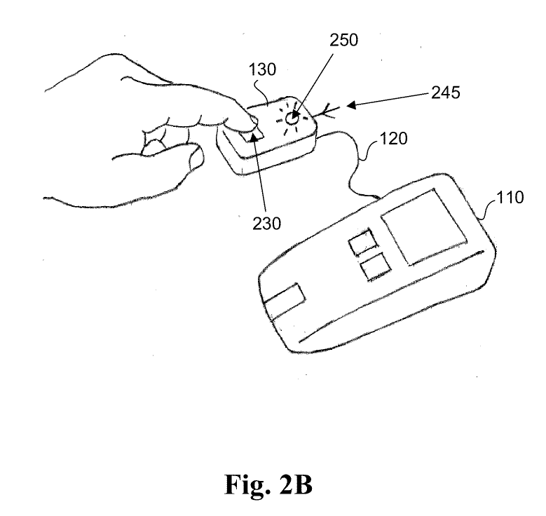

The transmission device 130 has the capability of collecting and storing the medical test data acquired or received from the test device 110. In addition, the transmission device 130 comprises one or more biometric scanners to acquire one or more biometric indicators from a test subject. The transmission device 130 captures the biometric indicators and links such with received medical test results. In an embodiment of the invention, the medical test data and the biometric indicators are linked by temporal proximity, i.e., the biometric indicator(s) would be linked to the immediate preceding, or immediate following medical test result obtained. The linked information is then transmitted to the data repository 150 via a network 140 utilizing one or more wired or wireless communications links such as, but not limited to a digital subscriber line (DSL), WiFi, Ethernet, Bluetooth, cellular network, and the Internet. The transmission device 130 is discussed in more detail in relation to FIG. 2 below.

The data repository 150 receives the medical test results linked to a particular test subject's biometric indicators. In an embodiment of the invention, the data repository 150 comprises hardware and/or software for authenticating the test subject's biometric indicators. For example, the received biometric indicators are compared to a database of biometric indicators associated with known individuals. Biometric authentication techniques are well known to one of ordinary skill in the art. Accordingly, an individual's identification, e.g., social security number or user ID, may be associated with the received biometric indicators and hence, the medical test data linked to such. In another embodiment of the invention, biometric authentication is performed at the transmission device 130 to identify the individual. In another embodiment of the invention, transmission and identity authentication are verified by display of the user ID on the transmission device, namely, one or more of the following: name, social security number, and date of birth. If authentication occurs at a remote data repository then the user ID is transmitted from the data repository 150 back to the transmission device 130 and displayed as verification that the information was received and authenticated.

In one embodiment of the invention, the data repository 150 is located remotely from the test subject, where a medical provider can access it. In this case, the data may be sent to the medical provider by, for example, extensible markup language (XML), fax, email, phone call, or by pager. In another exemplary embodiment, the data repository 150 is local, such as a local computer or cell or smart phone, and the linked information can be transmitted to the medical provider by way of email, short messaging service (SMS), facsimile (fax), or multimedia messaging service (MMS).

FIG. 2 illustrates the transmission device 130 according to an embodiment of the invention. The transmission device 130 is attached to the test device 110 and communicates information to the data repository 150. Referring to FIG. 2A, the transmission device 130 comprises a data input 210, a processor 220, a biometric scanner 230, a transmitter 240, a light 250, and a memory 260. The processor 220 is attached to the data input 210, the biometric scanner 230, the transmitter 240, the light 250, and the memory 260. The processor links the test subject's unique information with the test results sent, for example, by creating an information packet comprising the combined information of subject information and test result. In one embodiment, the processor 220 receives the test subject's biometric information from the biometric scanner 230 and receives the test results from the test device 110, links this information, and provides this linked information to the transmitter 240 for transmitting the information to the data repository 150. In another embodiment, the processor 220 links the received biometric information with a test subject's user ID from the memory 260, and links the test results to the test subject's user ID, and provides this linked information to the transmitter 240 for transmitting to the data repository 150.

The biometric scanner 230 is attached to the processor 220 and can be touched by a test subject's finger in order to scan the test subject's fingerprint as an exemplary embodiment of the invention. Of course, any type of biometric indicator (or any combination of biometric indicators) can be acquired via the biometric scanner 230. The biometric scanner 230 comprises hardware and software that detects the test subject's unique biometric indicators before the test results are linked to a particular test subject and transmitted to the data repository 150. Referring to FIG. 2B, the transmission device 130 can be triggered to power on by the touching of a finger to the biometric scanner 230, e.g., fingerprint scanner, according to an exemplary embodiment of the invention.

The biometric scanner 230 is an identification part that easily identifies the test subject. Examples of the biometric scanner 230 include a fingerprint scanner, a retinal scanner, a finger vein scanner, and/or a biometric detector that detects other unique personal identifying information, the identification and implementation of which are apparent to one of ordinary skill in the art. If a fingerprint scanner is used, the scanner can be a rolling fingerprint scanner, where the finger is “rolled” across a sensor, or a static fingerprint scanner, either optical or capacitative, the implementation of which is apparent to one of ordinary skill in the art. The scanning process can constitute the physical action that enables transmission, so that the scanning device can be the transmission button, switch, or other enabler, such that the act of scanning or inputting biometric information automatically causes transmission of the test results or other information, where this information is linked with the result of the subject performing the scan.

In one embodiment, the biometric scanner 230 can turn on the transmission device 130 when the test subject touches the biometric scanner 230. In another embodiment, the test subject can turn on the transmission device 130 by touching any of its buttons, or by attaching the transmission device 130 to the test device 110. When the transmission device 130 is turned on, information that has not been sent is sent at that time. To conserve power the transmission device can be powered off when it is disconnected from the test device, or when there has been no activity for a given period of time.

The transmitter 240 is attached to the processor 220. The transmitter 240 transmits the test results that are linked to the test subject to the data repository 150. The transmitter 240 can be a wireless transmitter such and include an RF or cellular transmitter, a Bluetooth transmitter, a connector cable, or other means for data transmission, the identification and implementation of all of which are apparent to one of ordinary skill in the art. An appropriate antenna 245 may be included to facilitate wireless communications.

In one embodiment, the transmission device 130 securely transmits information, by having encryption software or hardware that encrypts the test results before the transmitter 240 sends the information. The transmission device 130 uses the biometric scanner 230 to identify and link the test results to the test subject, as opposed to using the biometric scanner 230 for security purposes, to determine who is authorized to access the test results.

The transmitter 240 communicates information to the data repository 150. In addition to the test results, the transmitter 240 can communicate information for troubleshooting the transmission device 130. As such, the transmission device 130 can be self-diagnostic. For example, when the batteries are low the transmission device 130 can transmit a signal to the data repository 150 so an operator or automatic response system can phone or otherwise contact the registered user of the transmission device 130 to remind them that the batteries need replacement. If a problem, such as dead batteries, prevents data transmission, then the transmission can be made to occur once the problem is rectified.

The light 250 is attached to the processor 220. The light 250 represents one or more lights on the transmission device 130 and can signal the user's attention. In one embodiment, the light 250 blinks or shows a particular color when data transmission has been completed. This light can also be a flashing light, blink differently, or show a different color if scanning or re-scanning is required. Instead of, or in addition to the light 250, an audible beep or other signal can be used, with different numbers of beeps signaling different instructions. The light 250 can be a light-emitting diode (LED). The light 250 can also alert the user when there is a problem, or can prompt the user that his biometric information is ready to be scanned.

The memory 260 is attached to the processor 220 and the data input 210. The transmission device 130 has the capability to store the information received from the data input 210 in memory 260 until transmission. The memory 260 allows additional functionality, such as a learning mode and storage of the test subject's user ID linked to the test subject's biometrics.

In learning mode, new biometric information is scanned, stored, and linked with the test subject's user ID. The test subject's user ID can include unique personal identifying information, such as a password, PIN number, name, birth date, and/or social security number. Learning may require a connection to an independent means of entering the user ID, such as a computer with a keyboard. Once learning is finished, the computer and keyboard would not be needed.

In one embodiment, the learning mode and memory occur locally on the transmission device 130. It is advantageous to have both the capability to recognize the individual's biometric scan and link the scan with the test subject's user ID locally, that way the person being scanned can be asked to re-scan prior to data transmission if, for example, the first scan were unrecognizable or of poor quality. As confirmation that the scan is valid and matches with a user ID in the database the user identification such as name, social security number, or date of birth, or any combination thereof, can be displayed. Display of the user identification can also serve as verification of the user's identity.

In another embodiment, the learning mode and memory occur remotely outside of the transmission device 130. In this embodiment, the test subject's biometric scan and linked user ID can be entered and stored remotely ahead of time and this learning process could be done at any remote location using any scanning device. This has the advantage that any data transmission device can then be used by any user at any location to input information, and the information would be analyzed and matched to the user ID remotely.

In one embodiment, if the test subject's biometric information is not stored locally, for example, in the memory of the transmission device, there would need to be an active connection between the transmission device 130 and the remote location where the original scan and user ID are stored in order to link the test results to the user ID associated with that scan, so that a re-scan can be requested immediately in the event of a bad or unrecognized scan. Thus, the transmission device 130 may also have a receiver, becoming a transmissions/receiving device 130. In another embodiment, an active connection at the time of scan would not be needed if the transmission device could recognize the features of a good scan, provided such features existed. Then the need to re-scan based on poor quality could be determined without requiring an association between the scan and the test subject. The association of a good scan with the test subject's user ID could be established later, such as at the data repository 150. Again, if this association could not be made, a signal could be sent to the user via the transmission/receiving device 130. As confirmation that a valid scan had been received and matches with a user ID in the data repository 150, a signal or information-containing message can be sent back to the transmission device 130 from the remote location so that the user identification, such as name, social security number, or date of birth, or any combination thereof, can be displayed on the transmission device 130. Display of the user identification can also serve as verification of the user's identity for the user.

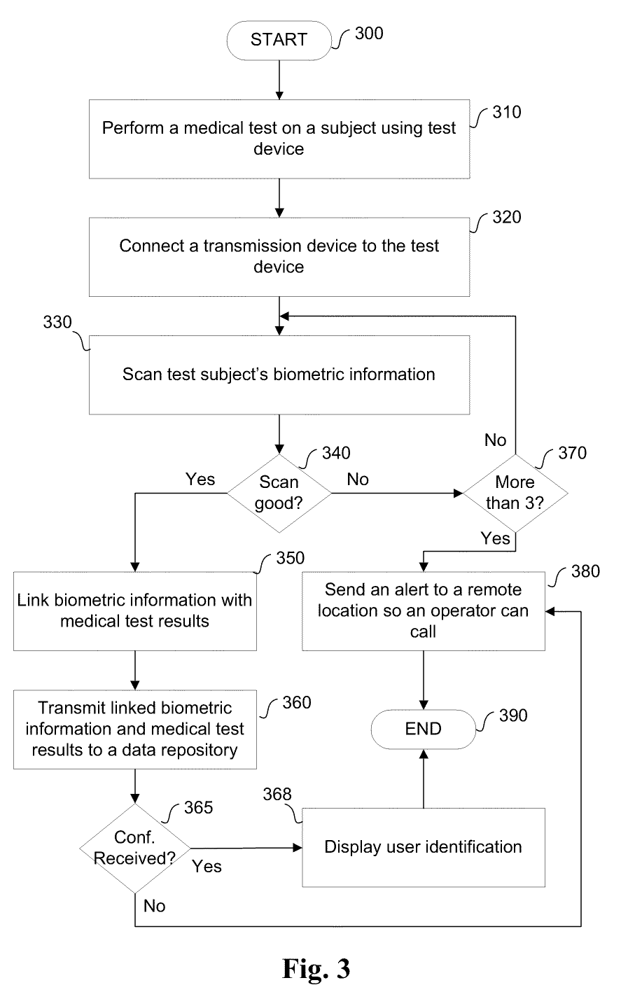

FIG. 3 illustrates a flow chart showing the process of linking a test subject's biometric information with the result of the test subject's medical test according to an embodiment of the invention. The process starts at step 300. At step 310, a user performs a new medical test on the test subject using the test device 110. The user can be the test subject, medical provider, or another person. Proceeding to step 320, the user connects the transmission device 130 to the test device 110 via the communications medium 120. The transmission device 130 can be connected before, during, or after the medical test is performed. Once the transmission device 130 is connected to the test device 110, the transmission device 130 turns on and detects if a new test has been performed.

Next, the user scans in the test subject's biometric information into the transmission device 130 at step 330. The light 250 can blink or shows a particular color when data transmission has been completed. Continuing to decision step 340, the transmission device 130 determines whether the scan is good. In one embodiment, the transmission device 130 determines if the scan is good by comparing the biometric scan with stored scans in the memory 260 to see if a user ID can be identified. In another embodiment, the transmission device 130 device determines if the scan is good based on certain quality features, such as the image's sharpness and pixel darkness. In yet another embodiment of the invention, the biometric scan is transmitted to a remote location to see if the scan matches a stored scan corresponding to a user ID.

If the scan is good, the process proceeds to step 350, where the transmission device 130 links the scanned biometric information with the results of the medical test. In another embodiment, the transmission device 130 links the scanned biometric information with a user ID stored in the memory 260, such that the results of the medical test are linked with the test subject's user ID. At step 360, the transmission device 130 transmits the linked information to the data repository 150. The data can be transmitted to the data repository 150 immediately, or after a wireless or other communication connection is made. At step 365, a confirmation that the test result and valid user ID have been received at the data repository 150 can be transmitted to the transmission device 130, which acts as a receiver, whereupon a light or other signal indicates successful receipt of the transmitted data. At step 368, a user identification of the test subject such as name or identification number, e.g., social security number, is displayed at the transmission device 130.

Alternatively, if the scan is not good because the scan quality is poor or the biometric information is not recognized, the process goes to decision step 370, where the memory 260 provides information whether there have been more than a predetermined number of bad scans, such as three bad scans. If there have been more than the predetermined number of bad scans, the process continues to step 380, where the transmission device 130 sends an alert to a remote location so an operator or automatic response system can call or otherwise contact the registered user of the transmission device 130 to resolve the issue or provide an alternative way to submit the test results. In another embodiment, the decision to alert the remote location is not based on the number of re-scans, but based on the amount of time without detecting a valid scan (for example, 30 minutes). Alternatively, if there have not been more than three bad scans, the process reverts back to step 330, to re-scan in the test subject's biometric information. As confirmation that a valid scan had been received and matches with a user ID in the database, a signal or information-containing message can be sent back to the transmission device from the remote location so that the user identification, such as name, social security number, or date of birth, or any combination thereof, can be displayed on the transmission device, step 370. Display of the user identification can also serve as verification of the user's identity for the user. The process ends with step 390.

It is to be recognized that depending on the embodiment, certain acts or events of any of the methods described herein can be performed in a different sequence, may be added, merged, or left out altogether (for example, not all described acts or events are necessary for the practice of the method). Moreover, in certain embodiments, acts or events may be performed concurrently, for example, through multi-threaded processing, interrupt processing, or multiple processors, rather than sequentially.

The steps of a method or algorithm described in connection with the embodiments disclosed herein may be embodied directly in a computer or electronic storage, in hardware, in a software module executed by a processor, or in a combination thereof. A software module may reside in a computer storage such as in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a mobile station. In the alternative, the processor and the storage medium may reside as discrete components in a mobile station.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

We claim:

1. A transmission device comprising:
a processor;
a data input attached to the processor, the data input configured to receive a medical test result;
a biometric scanner attached to the processor, the biometric scanner configured to receive scanned biometric information from a test subject;
a memory attached to the processor, the memory configured to store test subject user identification and test subject biometric information, wherein the processor receives a user identification corresponding to the scanned biometric information and the processor links the user identification to the medical test result; and
a transmitter attached to the processor, the transmitter configured to transmit the linked user identification and medical test result.

2. The transmission device of claim 1, wherein the medical test result comprises information selected from the group consisting of: date and time of test, type of test, test result, test calibration information, test control results, lot numbers of test materials, expiration date of test materials, medical test device identification, medical test device calibration information, information on the status of the medical test device, and any combination thereof.

3. The transmission device of claim 1, wherein the data input is attached to a cable.

4. The transmission device of claim 3, wherein the cable is attached to a test device.

5. The transmission device of claim 1, wherein the transmitter communicates with a network.

6. The transmission device of claim 5, wherein the network communicates with a data repository accessible by a medical provider.

7. A transmission device comprising:
a processor;
a data input attached to the processor, the data input configured to receive a medical test result;
a biometric scanner attached to the processor, the biometric scanner configured to receive scanned biometric information from a medical test subject, wherein the processor receives the scanned biometric information and the processor links the scanned biometric information to the medical test result; and
a transmitter attached to the processor, the transmitter configured to transmit the linked scanned biometric information and medical test result.

8. The transmission device of claim 7, further comprising a memory for storing at least one of a medical test result, a test subject's biometric information, and a test subject's user identification.

9. The transmission device of claim 7, further comprising a light.

10. The transmission device of claim 7, wherein the data input is attached to a cable.

11. The transmission device of claim 10, wherein the cable is attached to a test device.

12. The transmission device of claim 7, wherein the transmitter communicates with a network.

13. The transmission device of claim 12, wherein the network communicates with a data repository accessible by a medical provider.

14. The transmission device of claim 8, further comprising a receiver for receiving confirmation from the data repository that the medical test result and the test subject's user identification have been received.

15. The transmission device of claim 14, further comprising a display for displaying the test subject's name, social security number, and/or date of birth upon authentication of the test subject's biometric information.

16. The transmission device of claim 7, further comprising a medical test device.

17. A method of transmitting medical information, the method comprising:
receiving a medical test result;
scanning biometric information from a test subject;
linking the scanned biometric information to the medical test result; and
transmitting the linked scanned biometric information and medical test result.

18. The method of claim 17, further comprising receiving a user identification corresponding to the scanned biometric information.

19. The method of claim 18, further comprising storing the user identification.

20. The method of claim 19, further comprising linking the user identification to the medical test result.

21. The method of claim 20, further comprising transmitting the linked user identification and medical test result.

22. The method of claim 21, wherein the step of scanning initiates the steps of linking and transmitting.
